(19) United States
(12) Patent Application Publication
(10) Pub. No.: US 2006/0146991 A1
(43) Pub. Date: Jul. 6, 2006

(54) Provisioning and management in a message publish/subscribe system

(75) Inventors: J. Barry Thompson, New York, NY (US); Kul Singh, New York, NY (US); Pierre Fraval, New York, NY (US)

Correspondence Address: BROWN RAYSMAN MILLSTEIN FELDER & STEINER LLP, 303 TWIN DOLPHIN DRIVE, SUITE 600, REDWOOD SHORES, CA, 94065, US

(73) Assignee: Tervela, Inc., New York, NY (US)

(21) Appl. No.: 11/327,526

(22) Filed: Jan. 5, 2006

Related U.S. Application Data
(60) Provisional application No. 60/641,988, filed on Jan. 6, 2005.
(60) Provisional application No. 60/688,983, filed on Jun. 8, 2005.

(51) Int. Cl. H04M 1/64

(52) U.S. Cl. 379/67.1

(57) ABSTRACT

Message publish/subscribe systems are required to process high message volumes with reduced latency and performance bottlenecks. The end-to-end middleware architecture proposed by the present invention is designed for high volume, low-latency messaging by providing, among other things, a central, single point provisioning and management for configuration, provisioning and monitoring system performance. This functionality complements the reduction of intermediary hops through neighbour-based routing and dynamic, real time, optimizing of system interconnect configurations and message transmission protocols.

### REFERENCE TO EARLIER-FILED APPLICATIONS

This application claims the benefit and incorporates by reference U.S. Provisional Application Ser. No. 60/641,988, filed Jan. 6, 2005, entitled “Event Router System and Method” and U.S. Provisional Application Ser. No. 60/688,983, filed Jun. 8, 2005, entitled “Hybrid Feed Handlers And Latency Measurement.”

This application is related to and incorporates by reference U.S. patent application Ser. No. ______ (Attorney Docket No. 50003-004), filed Dec. 23, 2005, entitled “End-To-End Publish/Subscribe Middleware Architecture.”

### FIELD OF THE INVENTION

The present invention relates to data messaging and more particularly to a provisioning and management system in a messaging system with a publish and subscribe (hereafter “publish/subscribe”) middleware architecture.

### BACKGROUND

The increasing level of performance required by data messaging infrastructures provides a compelling rationale for advances in networking infrastructure and protocols. Fundamentally, data distribution involves various sources and destinations of data, as well as various types of interconnect architectures and modes of communications between the data sources and destinations. Examples of existing data messaging architectures include hub-and-spoke, peer-to-peer and store-and-forward.

With the hub-and-spoke system configuration, all communications are transported through the hub, often creating performance bottlenecks when processing high volumes. Therefore, this messaging system architecture produces latency. One way to work around this bottleneck is to deploy more servers and distribute the network load across these different servers. However, such architecture presents scalability and operational problems. By comparison to a system with the hub-and-spoke configuration, a system with a peer-to-peer configuration creates unnecessary stress on the applications to process and filter data and is only as fast as its slowest consumer or node. Then, with a store-and-forward system configuration, in order to provide persistence, the system stores the data before forwarding it to the next node in the path. The storage operation is usually done by indexing and writing the messages to a disk, and this potentially creates performance bottlenecks. Furthermore, when message volumes increase, the indexing and writing tasks can be even slower and thus, can introduces additional latency.

Existing data messaging architectures share a number of deficiencies. One common deficiency is that data messaging in existing architectures relies on software that resides at the application level. This implies that the messaging infrastructure experiences OS (operating system) queuing and network I/O (input/output), which potentially create performance bottlenecks. Another common deficiency is that existing architectures use data transport protocols statically rather than dynamically even if other protocols might be more suitable under the circumstances. A few examples of common protocols include routable multicast, broadcast or unicast. Indeed, the application programming interface (API) in existing architectures is not designed to switch between transport protocols in real time.

Also, network configuration decisions are usually made at deployment time and are usually defined to optimize one set of network and messaging conditions under specific assumptions. The limitations associated with static (fixed) configuration preclude real time dynamic network reconfiguration. In other words, existing architectures are configured for a specific transport protocol which is not always suitable for all network data transport load conditions and therefore existing architectures are often incapable of dealing, in real-time, with changes or increased load capacity requirements.

Furthermore, when data messaging is targeted for particular recipients or groups of recipients, existing messaging architectures use routable multicast for transporting data across networks. However, in a system set up for multicast there is a limitation on the number of multicast groups that can be used to distribute the data and, as a result, the messaging system ends up sending data to destinations which are not subscribed to it (i.e., consumers which are not subscribers). This increases consumers' data processing load and discard rate due to data filtering. Then, consumers that become overloaded for any reason and cannot keep up with the flow of data eventually drop incoming data and later ask for retransmissions. Retransmissions affect the entire system in that all consumers receive the repeat transmissions and all of them re-process the incoming data. Therefore, retransmissions can cause multicast storms and eventually bring the entire networked system down.

When the system is set up for unicast messaging as a way to reduce the discard rate, the messaging system may experience bandwidth saturation because of data duplication. For instance, if more than one consumer subscribes to a given topic of interest, the messaging system has to deliver the data to each subscriber, and in fact it sends a different copy of this data to each subscriber. And, although this solves the problem of consumers filtering out non-subscribed data, unicast transmission is non-scalable and thus not adaptable to substantially large groups of consumers subscribing to a particular data or to a significant overlap in consumption patterns.

One more common deficiency of existing architectures is their slow and often high number of protocol transformations. The reason for this is the IT (information technology) band-aid strategy in the Enterprise Application Integration (EIA) domain, where more and more new technologies are integrated with legacy systems.

Hence, there is a need to improve data messaging systems performance in a number of areas. Examples where performance might need improvement are speed, resource allocation, latency, and the like.

### SUMMARY OF THE INVENTION

The present invention is based, in part, on the foregoing observations and on the idea that such deficiencies can be addressed with better results using a different approach. These observations gave rise to the end-to-end message publish/subscribe architecture for high-volume and low-latency messaging. So therefore, a data distribution system with end-to-end message publish/subscribe architecture in accordance with the principles of the present invention also includes a provisioning and management (P&M) system and method. The P&M system and method facilitates the improved performance of a messaging system with the end-to-end message publish/subscribe architecture. Such improved performance is manifested, for instance, by significantly higher message volumes with significantly lower latency achieved by, among other things, reducing intermediary hops with neighbour-based routing and network disintermediation, introducing efficient native-to-external and external-to-native protocol conversions, monitoring system performance, including latency, in real time, employing topic-based and channel-based message communications, and dynamically and intelligently optimizing system interconnect configurations and message transmission protocols. The improved performance is further represented by guaranteed delivery quality of service with data caching.

Hence, in accordance with principles of the present invention, P&M systems are designed with functionality that supports the improved operations of a message publish/subscribe system. For instance, a typical P&M system is designed to provide centralized, single-point management, including configuration and monitoring of the publish/subscribe messaging system components as well as reporting status and errors.

The configuration management functionality a typical P&M system is designed to provide involves users management, digital rights management (DRM) and namespace management, entitlements management, network management services configuration, topology management with LAN and WAN links, and the like. Moreover, P&M system provides real-time data processing functionality without impacting data traffic by, for instance, managing separate virtual fabrics (VLANs) where each messaging appliance (MA) has a separate connection to each of the VLANs.

A P&M system can optionally provide provisioning, and this functionality is preferably provided in conjunction with the centralized, single-point management. Provisioning allows software and firmware version control and update-over-the-wire management and scheduling. With such centralized configuration, there is no risk of bottlenecks because the time to query application programming interfaces (APIs) is at start-up and setup phases and not during normal runtime (time of service) operations. For health and event monitoring, the P&M is designed to provide reports on all status changes in the message publish/subscribe system (including new registrations of users and applications, new publication/subscription events, network and messaging connection/disconnection, etc.). The P&M is designed to further provide end-to-end messaging system performance control and monitoring. This involves reservation of resource for messaging communication paths (considering network bandwidth, message rates, frame rates, messaging hop latency, end-to-end latency, dynamic behavior policies for services, such as dynamic routing, protocol optimization services, real-time conflation and message flow control, etc.).

In connection with the foregoing, the P&M system is designed to communicate with the various components of the message publish/subscribe system. Communicating with the P&M system often involves exchange of query and response messages between components of the message publish/subscribe system and it often also involves the P&M system ‘pushing’ messages to these components (to provide new subscription updates or any other information).

Generally, P&M systems are implemented with messaging logic and back-end database and they include user interface capability, such as graphic user interface (GUI), for system configuration, reconfiguration and monitoring. As with other components in the message publish/subscribe system, P&M systems are preferably designed for fault-tolerance and this capability can be implemented with database replication or data synchronization at the messaging level.

Alternatively, the P&M can be integrated with existing external authentication and entitlement systems, such as LDAP (light weight directory access protocol) or other custom systems (external to the middleware architecture). This will allow a company to implement a uniform user authentication and entitlements. As a result, the P&M system functions as a gateway between such external system and the messaging system components.

Thus, in accordance with the purpose of the invention as shown and broadly described herein one exemplary messaging system with a publish/subscribe middleware architecture that has a P&M system includes: one or more than one messaging appliance operative for receiving and routing messages, including administrative and data messages; an interconnect; and one or more than one provisioning and management system linked to the one or more messaging appliances via the interconnect. The provisioning and management system is operative to provide centralized, single-point management for the messaging system via communications of administrative messages. The centralized, single-point management includes configuration management, messaging system monitoring and reporting. Optionally, the provisioning and management system is operative to provide centralized, single point provisioning, including software and firmware version control and update management and scheduling. Preferably, the interconnect includes a plurality of fabrics, one fabric of which being used for administrative messages and another fabric of which being used for data messages.

In sum, these and other features, aspects and advantages of the present invention will become better understood from the description herein, appended claims, and accompanying drawings as hereafter described.

### BRIEF DESCRIPTION OF THE DRAWINGS

The accompanying drawings, which are incorporated in and constitute a part of this specification, illustrate various aspects of the invention and together with the description, serve to explain its principles. Wherever convenient, the same reference numbers will be used throughout the drawings to refer to the same or like elements.

FIG. 1 illustrates an end-to-end middleware architecture in accordance with the principles of the present invention.

FIG. 1a is a diagram illustrating an overlay network.

FIG. 2 is a diagram illustrating an enterprise infrastructure implemented with an end-to-end middleware architecture according to the principles of the present invention.

FIG. 2a is a diagram illustrating an enterprise infrastructure physical deployment with the message appliances (MAs) creating a network backbone disintermediation.

FIG. 3 illustrates channel-based messaging system architecture.

FIG. 4 illustrates one possible topic-based message format.

FIG. 5 shows a topic-based message routing and routing table.

FIG. 6 illustrates a messaging (publish/subscribe) system with a namespace-based topology.

FIG. 7 is a block diagram illustrating a provisioning and management (P&M) system in accordance with one embodiment of the invention.

FIG. 8 is a diagram illustrating the communication between the P&M system and one of the message appliances (MAs).

FIG. 9 illustrates the separation of data and administrative message traffic through two VLANS.

### DETAILED DESCRIPTION

Before outlining the details of various embodiments involving the provisioning and management (P&M) system in accordance with aspects and principles of the present invention the following is a brief explanation of some terms that may be used throughout this description. It is noted that this explanation is intended to merely clarify and give the reader an understanding of how such terms might be used, but without limiting these terms to the context in which they are used and without limiting the scope of the claims thereby.

The term “middleware” is used in the computer industry as a general term for any programming that mediates between two separate and often already existing programs. Typically, middleware programs provide messaging services so that different applications can communicate. The systematic tying together of disparate applications, often through the use of middleware, is known as enterprise application integration (EAI). In this context, however, “middleware” can be a broader term used in the context of messaging between source and destination and the facilities deployed to enable such messaging; and, thus, middleware architecture covers the networking and computer hardware and software components that facilitate effective data messaging, individually and in combination as will be described below. Moreover, the terms “messaging system” or “middleware system,” can be used in the context of publish/subscribe systems in which messaging servers manage the routing of messages between publishers and subscribers. Indeed, the paradigm of publish/subscribe in messaging middleware is a scalable and thus powerful model.

The term “consumer” may be used in the context of client-server applications and the like. In one instance a consumer is a system or an application that uses an application programming interface (API) to register to a middleware system, to subscribe to information, and to receive data delivered by the middleware system. An API inside the middleware architecture boundaries is a consumer; and an external consumer is any publish/subscribe system (or external data destination) that doesn't use the API and for communications with which messages go through protocol transformation (as will be later explained).

The term “external data source” may be used in the context of data distribution and message publish/subscribe systems. In one instance, an external data source is regarded as a system or application, located within or outside the enterprise private network, which publishes messages in one of the common protocols or its own message protocol. An example of an external data source is a market data exchange that publishes stock market quotes which are distributed to traders via the middleware system. Another example of an external data source is transactional data. Note that in a typical implementation of the present invention, as will be later described in more detail, the middleware architecture adopts its unique native protocol to which data from external data sources is converted once it enters the middleware system domain, thereby avoiding multiple protocol transformations typical of conventional systems.

The term “external data destination” is also used in the context of data distributions and message publish/subscribe systems. An external data destination is, for instance, a system or application, located within or outside the enterprise private network, which is subscribing to information routed via a local/global network. One example of an external data destination could be the aforementioned market data exchange that handles transaction orders published by the traders. Another example of an external data destination is transactional data. Note that, in the foregoing middleware architecture messages directed to an external data destination are translated from the native protocol to the external protocol associated with the external data destination.

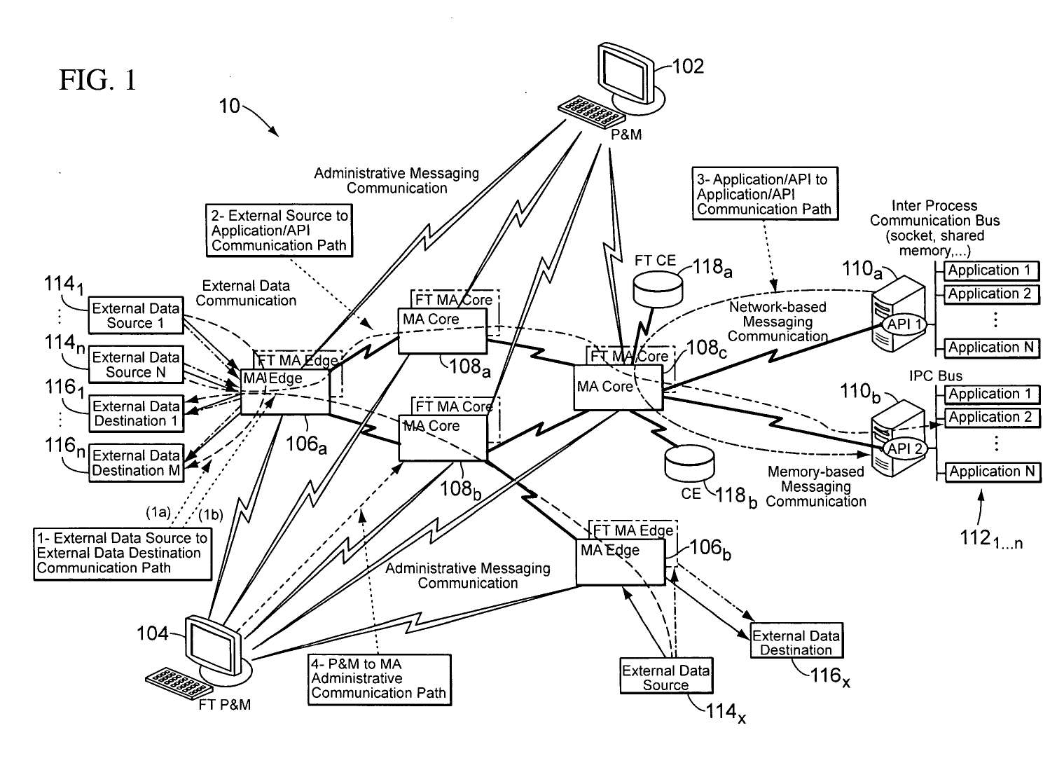

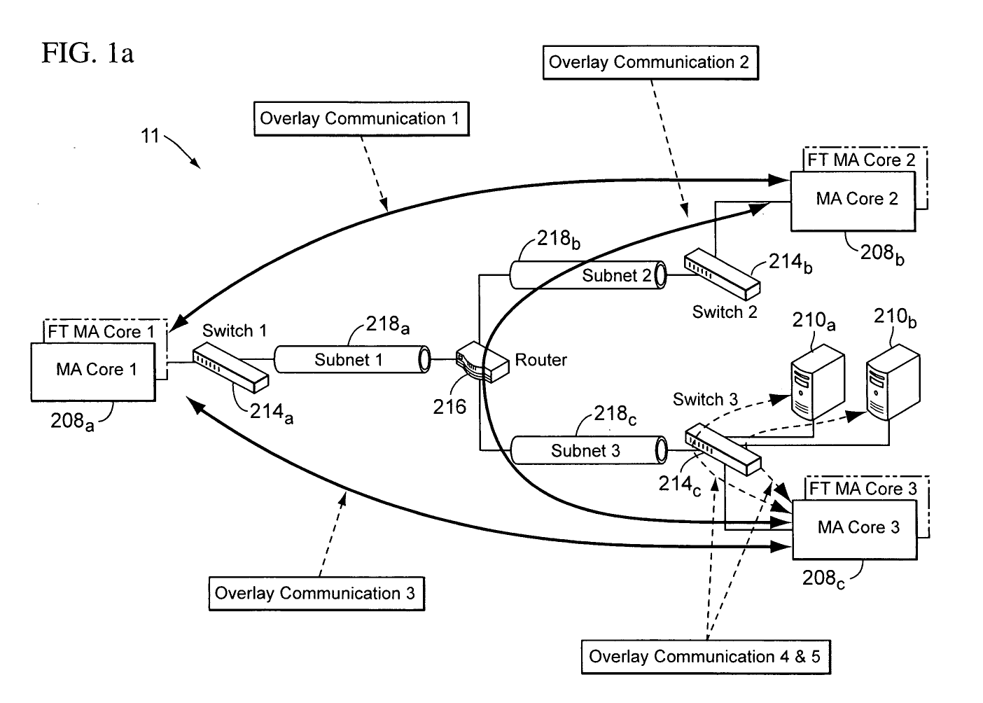

As can be ascertained from the description herein, the present invention can be practiced in various ways with various configurations, each embodied in middleware architecture. An example of end-to-end middleware architecture in accordance with the principles of the present invention is shown in FIG. 1.

This exemplary architecture combines a number of beneficial features which include: messaging common concepts, APIs, fault tolerance, provisioning and management (P&M), quality of service (QoS—conflated, best-effort, guaranteed-while-connected, guaranteed-while-disconnected etc.), persistent caching for guaranteed delivery QoS, management of namespace and security service, a publish/subscribe ecosystem (core, ingress and egress components), transport-transparent messaging, neighbor-based messaging (a model that is a hybrid between hub-and-spoke, peer-to-peer, and store-and-forward, and which uses a subscription-based routing protocol that can propagate the subscriptions to all neighbors as necessary), late schema binding, partial publishing (publishing changed information only as opposed to the entire data) and dynamic allocation of network and system resources. As will be later explained, the publish/subscribe system advantageously incorporates a fault tolerant design of the middleware architecture. Note that the core MAs portion of the publish/subscribe ecosystem uses the aforementioned native messaging protocol (native to the middleware system) while the ingress and egress portions, the edge MAs, translate to and from this native protocol, respectively.

In addition to the publish/subscribe system components, the diagram of FIG. 1 shows the logical connections and communications between them. As can be seen, the illustrated middleware architecture is that of a distributed system. In a system with this architecture, a logical communication between two distinct physical components is established with a message stream and associated message protocol. The message stream contains one of two categories of messages: administrative and data messages. The administrative messages are used for management and control of the different physical components, management of subscriptions to data, and more. The data messages are used for transporting data between sources and destinations, and in a typical publish/subscribe messaging there are multiple senders and multiple receivers of data messages.

With the structural configuration and logical communications as illustrated the distributed publish/subscribe system with the middleware architecture is designed to perform a number of logical functions. One logical function is message protocol translation which is advantageously performed at an edge messaging appliance (MA) component. A second logical function is routing the messages from publishers to subscribers. Note that the messages are routed throughout the publish/subscribe network. Thus, the routing function is performed by each MA where messages are propagated, say, from an edge MA 106a-b (or API) to a core MA 108a-c or from one core MA to another core MA and eventually to an edge MA (e.g., 106b) or API 110a-b. The API 110a-b communicates with applications 112₁₋ₙ via an inter-process communication bus (sockets, shared memory etc.).

A third logical function is storing messages for different types of guaranteed-delivery quality of service, including for instance guaranteed-while-connected and guaranteed-while-disconnected. A fourth function is delivering these messages to the subscribers. As shown, an API 106a-b delivers messages to subscribing applications 112₁₋ₙ.

In every publish/subscribe middleware architecture, the system configuration function, as well as other administrative and system performance monitoring functions, are managed by the P&M system. Additionally, the MAs are deployed as edge MAs or core MAs, depending on their role in the network. An edge MA is similar to a core MA in most respects, except that it includes a protocol translation engine that transforms messages from external to native protocols and from native to external protocols. Thus, in general, the boundaries of the publish/subscribe system middleware architecture are characterized by its edges at which there are edge MAs 106a-b and APIs 110a-b; and within these boundaries there are core MAs 108a-c.

In a typical system, the core MAs 108a-c route the published messages internally within the system towards the edge MAs or APIs (e.g., APIs 110a-b). The routing map, particularly in the core MAs, is designed for maximum volume, low latency, and efficient routing. Moreover, the routing between the core MAs can change dynamically in real-time. For a given messaging path that traverses a number of nodes (core MAs), a real time change of routing is based on one or more metrics, including network utilization, overall end-to-end latency, communications volume, network delay, loss and jitter.

Alternatively, instead of dynamically selecting the best performing path out of two or more diverse paths, the MA can perform multi-path routing based on message replication and thus send the same message across all paths. All the MAs located at convergence points of diverse paths will drop the duplicated messages and forward only the first arrived message. This routing approach has the advantage of optimizing the messaging infrastructure for low latency; although the drawback of this routing method is that the infrastructure requires more network bandwidth to carry the duplicated traffic.

Note that the system architecture is not confined to a particular limited geographic area and, in fact, is designed to transcend regional or national boundaries and even span across continents. In such cases, the edge MAs in one network can communicate with the edge MAs in another geographically distant network via existing networking infrastructures.

The edge MAs have the ability to convert any external message protocol of incoming messages to the middleware system's native message protocol; and from native to external protocol for outgoing messages. That is, an external protocol is converted to the native (e.g., Tervela™) message protocol when messages are entering the publish/subscribe network domain (ingress); and the native protocol is converted into the external protocol when messages exit the publish/subscribe network domain (egress). Another function of edge MAs is to deliver the published messages to the subscribing external data destinations.

Additionally, both the edge and the core MAs 106a-b and 108a-c are capable of storing the messages before forwarding them. One way this can be done is with a caching engine (CE) 118a-b. One or more CEs can be connected to the same MA. Theoretically, the API is said not to have this store-and-forward capability although in reality an API 110a-b could store messages before delivering them to the application, and it can store messages received from applications before delivering them to a core MA, edge MA or another API.

When an MA (edge or core MA) has an active connection to a CE, it forwards all or a subset of the routed messages to the CE which writes them to a storage area for persistency. For a predetermined period of time, these messages are then available for retransmission upon request. Examples where this feature is implemented are data replay, partial publish and various quality of service levels. Partial publish is effective in reducing network and consumers load because it requires transmission only of updated information rather than of all information.

To illustrate how the routing maps might effect routing, a few examples of the publish/subscribe routing paths are shown in FIG. 1. In this illustration, the middleware architecture of the publish/subscribe network provides five or more different communication paths between publishers and subscribers.

The first communication path links an external data source to an external data destination. The published messages received from the external data source 114₁₋ₙ are translated into the native (e.g., Tervela™) message protocol and then routed by the edge MA 106a. One way the native protocol messages can be routed from the edge MA 106a is to an external data destination 116n. This path is called out as communication path 1a. In this case, the native protocol messages are converted into the external protocol messages suitable for the external data destination. Another way the native protocol messages can be routed from the edge MA 106b is internally through a core MA 108b. This path is called out as communication path 1b. Along this path, the core MA108b routes the native messages to an edge MA 106a. However, before the edge MA 106a routes the native protocol messages to the external data destination 116₁, it converts them into an external message protocol suitable for this external data destination 116₁. As can be seen, this communication path doesn't require the API to route the messages from the publishers to the subscribers. Therefore, if the publish/subscribe system is used for external source-to-destination communications, the system need not include an API.

Another communication path, called out as communications path 2, links an external data source 1 14n to an application using the API 110b. Published messages received from the external data source are translated at the edge MA 106a into the native message protocol and are then routed by the edge MA to a core MA 108a. From the first core MA 108a, the messages are routed through another core MA 108c to the API 110b. From the API the messages are delivered to subscribing applications (e.g., 112₂). Because the communication paths are bidirectional, in another instance, messages could follow a reverse path from the subscribing applications 112₁₋ₙ to the external data destination 116n. In each instance, core MAs receive and route native protocol messages while edge MAs receive external or native protocol messages and, respectively, route native or external protocol messages (edge MAs translate to/from such external message protocol to/from the native message protocol). Each of the edge MAs can route an ingress message simultaneously to both native protocol channels and external protocol channels. As a result, each edge MA can route an ingress message simultaneously to both external and internal consumers, where internal consumers consume native protocol messages and external consumers consume external protocol messages. This capability enables the messaging infrastructure to seamlessly and smoothly integrate with legacy applications and systems.

Yet another communication path, called out as communications path 3, links two applications, both using an API 110a-b. At least one of the applications publishes messages or subscribes to messages. The delivery of published messages to (or from) subscribing (or publishing) applications is done via an API that sits on the edge of the publish/subscribe network. When applications subscribe to messages, one of the core or edge MAs routes the messages towards the API which, in turn, notifies the subscribing applications when the data is ready to be delivered to them. Messages published from an application are sent via the API to the core MA 108c to which the API is ‘registered’.

Note that by ‘registering’ (logging in) to an MA, the API becomes logically connected to it. An API initiates the connection to the MA by sending a registration (a ‘log-in’ request) message to the MA. After registration, the API can subscribe to particular topics of interest by sending its subscription messages to the MA. Topics are used for publish/subscribe messaging to define shared access domains and the targets for a message, and therefore a subscription to one or more topics permits reception and transmission of messages with such topic notations.

The P&M sends to the MAs in the network periodic entitlement updates and each MA updates its own table accordingly. Hence, if the MA find the API to be entitled to subscribe to a particular topic (the MA verifies the API's entitlements using the routing entitlements table) the MA activates the logical connection to the API. Then, if the API is properly registered with it, the core MA 108c routes the data to the second API 110 as shown. In other instances this core MA 108b may route the messages through additional one or more core MAs (not shown) which route the messages to the API 110b that, in turn, delivers the messages to subscribing applications 112₁₋ₙ.

As can be seen, communications path 3 doesn't require the presence of an edge MA, because it doesn't involve any external data message protocol. In one embodiment exemplifying this kind of communications path, an enterprise system is configured with a news server that publishes to employees the latest news on various topics. To receive the news, employees subscribe to their topics of interest via a news browser application using the API.

Note that the middleware architecture allows subscription to one or more topics. Moreover, this architecture allows subscription to a group of related topics with a single subscription request, by allowing wildcards in the topic notation.

Yet another path, called out as communications path 4, is one of the many paths associated with the P&M system 102 and 104 with each of them linking the P&M to one of the MAs in the publish/subscribe network middleware architecture. The messages going back and forth between the P&M system and each MA are administrative messages used to configure and monitor that MA. In one system configuration, the P&M system communicates directly with the MAs. In another system configuration, the P&M system communicates with MAs through other MAs. In yet another configuration the P&M system can communicate with the MAs both directly or indirectly.

In a typical implementation, the middleware architecture can be deployed over a network with switches, router and other networking appliances, and it employs channel-based messaging capable of communications over any type of physical medium. One exemplary implementation of this fabric-agnostic channel-based messaging is an IP-based network. In this environment, all communications between all the publish/subscribe physical components are performed over UDP (User Datagram Protocol), and the transport reliability is provided by the messaging layer. An overlay network according to this principle is illustrated in FIG. 1a.

As shown, overlay communications 1, 2 and 3 can occur between the three core MAs 208a-c via switches 214a-c, a router 216 and subnets 218a-c. In other words, these communication paths can be established on top of the underlying network that includes networking infrastructure such as subnets, switches and routers, and, as mentioned, this architecture can span over a large geographic area (different countries and even different continents).

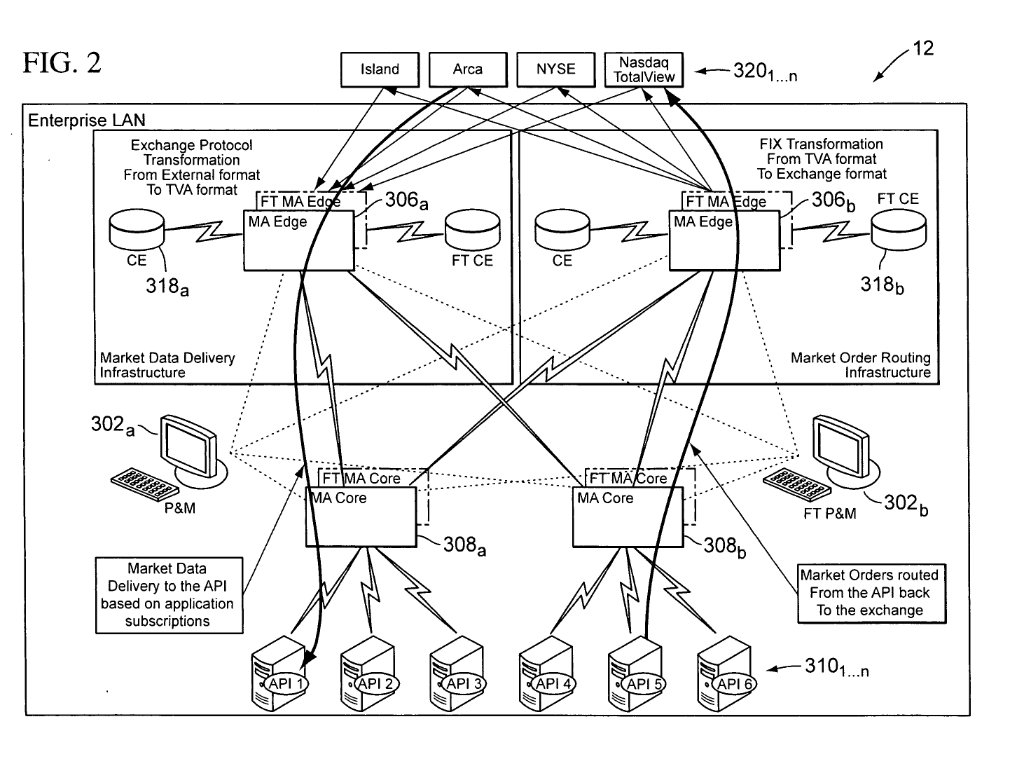

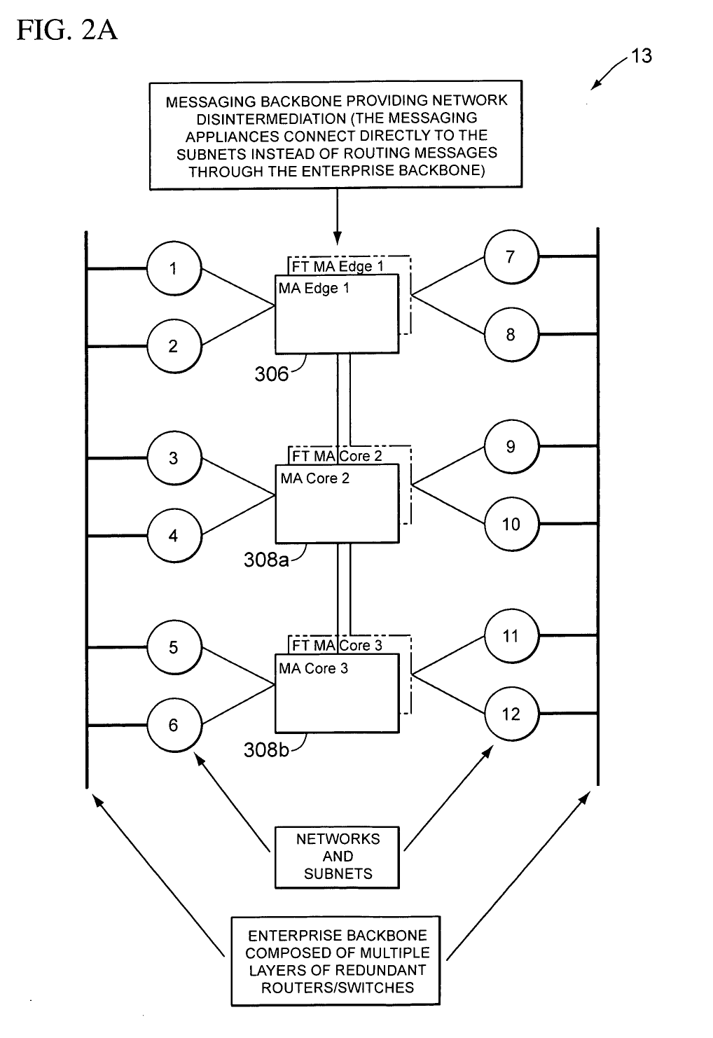

The foregoing and other end-to-end middleware architectures according to the principles of the present invention can be implemented in various enterprise infrastructures in various business environments. One such implementation is illustrated on FIG. 2.

In this enterprise infrastructure, a market data distribution plant 12 is built on top of the publish/subscribe network for routing stock market quotes from the various market data exchanges 320₁₋ₙ to the traders (applications not shown). Such an overlay solution relies on the underlying network for providing interconnects, for instance, between the MAs as well as between such MAs and the P&M system. Market data delivery to the APIs 310₁₋ₙ is based on applications subscription. With this infrastructure, traders using the applications (not shown) can place transaction orders that are routed from the APIs 310₁₋ₙ through the publish/subscribe network (via core MAs 308a-b and the edge MA 306b) back to the market data exchanges 320₁₋ₙ.

An example of the underlying physical deployment is illustrated on FIG. 2a. As shown, the MAs are directly connected to each other and plugged directly into the networks and subnets in which the consumers and publishers of messaging traffic are physically connected. In this case, interconnects would be the direct connections, say, between the MAs as well as between them and the P&M system. This enables a network backbone disintermediation and a physical separation of the messaging traffic from other enterprise applications traffic. Effectively, the MAs can be used to remove the reliance on traditional routed network for the messaging traffic.

In this example of physical deployment, the external data sources or destinations, such as market data exchanges, are directly connected to edge MAs, for instance edge MA 1. The consuming or publishing applications of messaging traffic, such as market trading applications, are connected to the subnets 1-12. These applications have at least two ways to subscribe, publish or communicate with other applications. The application could either use the enterprise backbone, composed of multiple layers of redundant routers and switches, which carries all enterprise application traffic, such as messaging traffic, or use the messaging backbone, composed of edge and core MAs directly interconnected to each other via an integrated switch. Using an alternative backbone has the benefit of isolating the messaging traffic from other enterprise application traffic, and thus better controlling the performance of the messaging traffic. In one implementation, an application located in subnet 6 logically or physically connected to the core MA 3, subscribes to or publishes messaging traffic in the native protocol, using the native protocol (e.g., Tervela™)-capable API. In another implementation, an application located in subnet 7 logically or physically connected to the edge MA 1, subscribes to or publishes the messaging traffic in an external protocol, where the MA performs the protocol transformation using the integrated protocol transformation engine module.

Logically, the physical components of the publish/subscribe network are built on a messaging transport layer akin to layers 1 to 4 of the Open Systems Interconnection (OSI) reference model. Layers 1 to 4 of the OSI model are respectively the Physical, Data Link, Network and Transport layers.

Thus, in one embodiment of the invention, the publish/subscribe network can be directly deployed into the underlying network/fabric by, for instance, inserting one or more messaging line card in all or a subset of the network switches and routers. In another embodiment of the invention, the publish/subscribe network can be deployed as a mesh overlay network (in which all the physical components are connected to each other). For instance, a fully meshed network of 4 MAs is a network in which each of the MAs is connected to each of its 3 peer MAs. In a typical implementation, the publish/subscribe network is a mesh network of one or more external data sources and/or destinations, one or more provisioning and management (P&M) systems, one or more messaging appliances (MAs), one or more optional caching engines (CE) and one or more optional application programming interfaces (APIs).

As will be later explained in more detail, reliability, availability and consistency are often necessary in enterprise operations. For this purpose, the publish/subscribe system can be designed for fault tolerance with several of its components being deployed as fault tolerant systems. For instance, MAs can be deployed as fault-tolerant MA pairs, where the first MA is called the primary MA, and the second MA is called the secondary MA or fault-tolerant MA (FT MA). Again, for store and forward operations, the CE (cache engine) can be connected to a primary or secondary core/edge MA. When a primary or secondary MA has an active connection to a CE, it forwards all or a subset of the routed messages to that CE which writes them to a storage area for persistency. For a predetermined period of time, these messages are then available for retransmission upon request.

Notably, communications throughout the publish/subscribe network are conducted using the native protocol messages independently from the underlying transport logic. This is why we refer to this architecture as a transport-transparent channel-based messaging architecture.

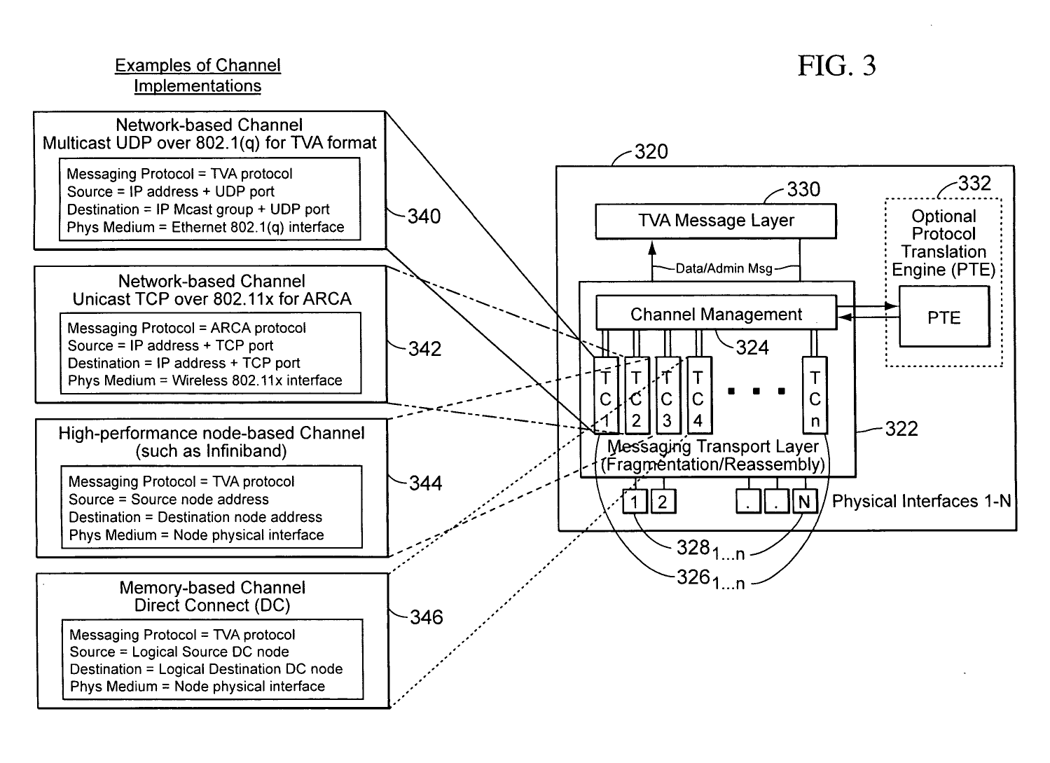

FIG. 3 illustrate in more details the channel-based messaging architecture 320. Generally, each communication path between the messaging source and destination is considered a messaging transport channel. Each channel 326₁₋ₙ, is established over a physical medium with interfaces 328₁₋ₙ between the channel source and the channel destination. Each such channel is established for a specific message protocol, such as the native (e.g., Tervela™) message protocol or others. Only edge MAs (those that manage the ingress and egress of the publish/subscribe network) use the channel message protocol (external message protocol). Based on the channel message protocol, the channel management layer 324 determines whether incoming and outgoing messages require protocol translation. In each edge MA, if the channel message protocol of incoming messages is different from the native protocol, the channel management layer 324 will perform a protocol translation by sending the message for process through the protocol translation engine (PTE) 332 before passing them along to the native message layer 330. Also, in each edge MA, if the native message protocol of outgoing messages is different from the channel message protocol (external message protocol), the channel management layer 324 will perform a protocol translation by sending the message for process through the protocol translation engine (PTE) 332 before routing them to the transport channel 326₁₋ₙ. Hence, the channel manages the interface 328₁₋ₙ with the physical medium as well as the specific network and transport logic associated with that physical medium and the message reassembly or fragmentation.

In other words, a channel manages the OSI transport to physical layers 322. Optimization of channel resources is done on a per channel basis (e.g., message density optimization for the physical medium based on consumption patterns, including bandwidth, message size distribution, channel destination resources and channel health statistics). Then, because the communication channels are fabric agnostic, no particular type of fabric is required. Indeed, any fabric medium will do, e.g., ATM, Infiniband or Ethernet.

Incidentally, message fragmentation or re-assembly may be needed when, for instance, a single message is split across multiple frames or multiple messages are packed in a single frame Message fragmentation or reassembly is done before delivering messages to the channel management layer.

FIG. 3 further illustrates a number of possible channels implementations in a network with the middleware architecture. In one implementation 340, the communication is done via a network-based channel using multicast over an Ethernet switched network which serves as the physical medium for such communications. In this implementation the source send messages from its IP address, via its UDP port, to the group of destinations (defined as an IP multicast address) with its associated UDP port. In a variation of this implementation 342, the communication between the source and destination is done over an Ethernet switched network using UDP unicast. From its IP address, the source sends messages, via a UDP port, to a select destination with a UDP port at its respective IP address.

In another implementation 344, the channel is established over an Infiniband interconnect using a native Infiniband transport protocol, where the Infiniband fabric is the physical medium. In this implementation the channel is node-based and communications between the source and destination are node-based using their respective node addresses. In yet another implementation 346, the channel is memory-based, such as RDMA (Remote Direct Memory Access), and referred to here as direct connect (DC). With this type of channel, messages are sent from a source machine directly into the destination machine's memory, thus, bypassing the CPU processing to handle the message from the NIC to the application memory space, and potentially bypassing the network overhead of encapsulating messages into network packets.

As to the native protocol, one approach uses the aforementioned native Tervela™ message protocol. Conceptually, the Tervela™ message protocol is similar to an IP-based protocol. Each message contains a message header and a message payload. The message header contains a number of fields one of which is for the topic information. As mentioned, a topic is used by consumers to subscribe to a shared domain of information.

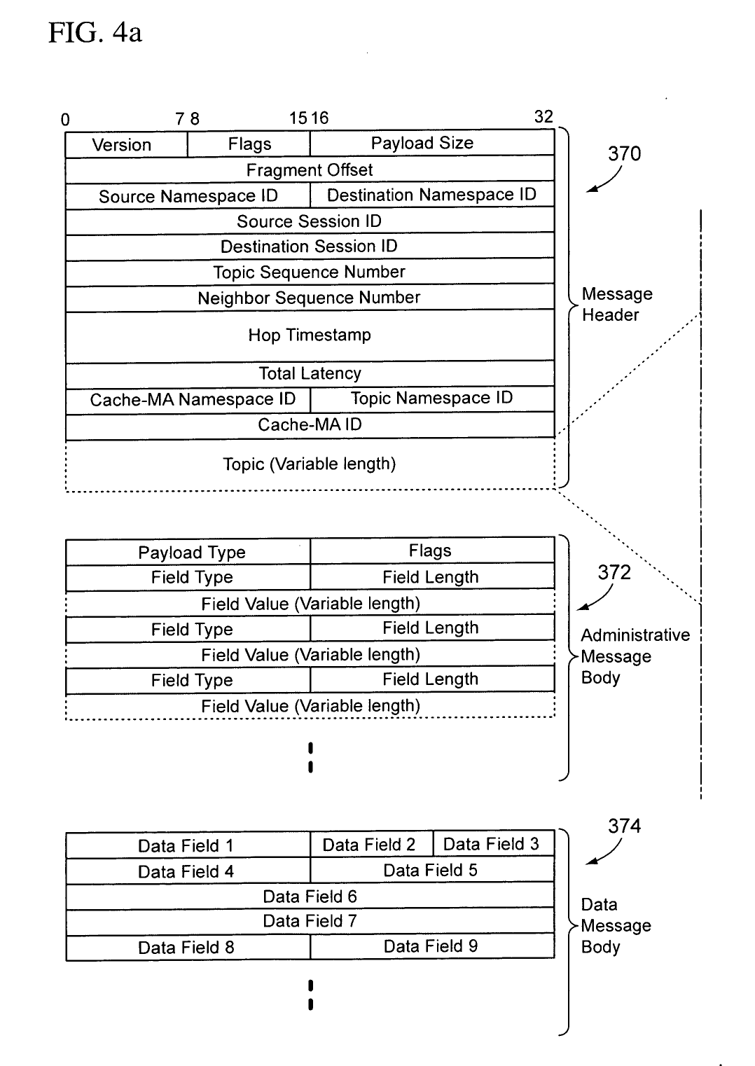

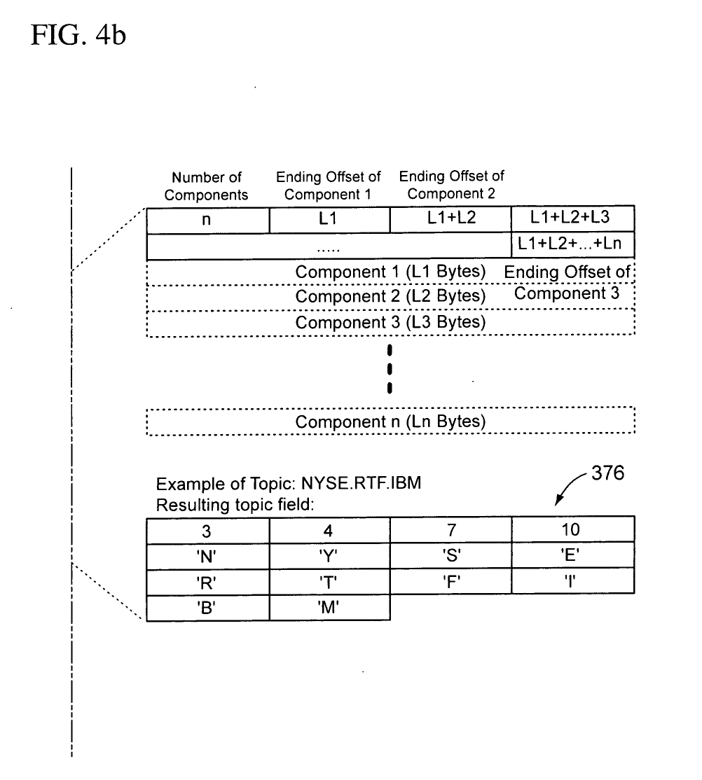

FIG. 4 illustrates one possible topic-based message format. As shown, messages include a header 370 and a body 372 and 374 which includes the payload. The two types of messages, data and administrative are shown with different message bodies and payload types. The header includes fields for the source and destination namespace identifications, source and destination session identifications, topic sequence number and hope timestamp, and, in addition, it includes the topic notation field (which is preferably of variable length). The topic might be defined as a token-based string, such as NYSE.RTF.IBM 376 which is the topic string for messages containing the real time quote of the IBM stock.

In some embodiment, the topic information in the message might be encoded or mapped to a key, which can be one or more integer values. Then, each topic would be mapped to a unique key, and the mapping database between topics and keys would be maintained by the P&M system and updated over the wire to all MAs. As a result, when an API subscribes or publishes to one topic, the MA is able to return the associated unique key that is used for the topic field of the message.

Preferably, the subscription format will follow the same format as the message topic. However, the subscription format also supports wildcards that match any topic substring or regular expression pattern-match against the topic. Handling of wildcard mapping to actual topics may be dependant on the P&M subsystem or handled by the MA depending on complexity of the wildcard or pattern-match request.

Pattern matching may follow rules as provided in the following examples.

Example #1: A string with a wildcard of T1.*.T3.T4 would match T1.T2a.T3.T4 and T1.T2b.T3.T4 but would not match T1.T2.T3.T4.T5

Example #2: A string with wildcards of T1.*.T3.T4.* would not match T1.T2a.T3.T4 and T1.T2b.T3.T4 but it would match T1.T2.T3.T4.T5

Example #3: A string with wildcards of T1.*.T3.T4.[*] (optional 5^{th} element) would match T1.T2a.T3.T4, T1.T2b.T3.T4 and T1.T2.T3.T4.T5 but would not match T1.T2.T3.T4.T5.T6

Example #4: A string with a wildcard of T1.T2*.T3.T4 would match T1.T2a.T3.T4 and T1.T2b.T3.T4 but would not match T1.T5a.T3.T4

Example #5: A string with wildcards of T1.*.T3.T4.> (any number of trailing elements) would match T1.T2a.T3.T4, T1.T2b.T3.T4, T1.T2.T3.T4.T5 and T1.T2.T3.T4.T5.T6.

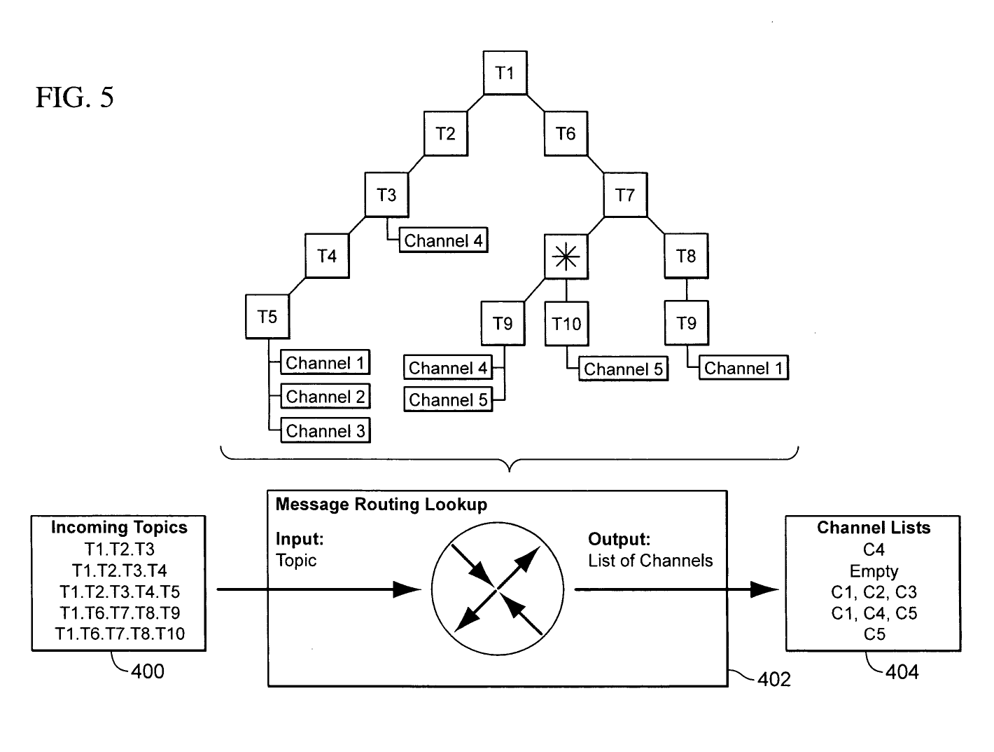

FIG. 5 shows topic-based message routing. As indicated, a topic might be defined as a token-based string, such as T1.T2.T3.T4, where T1, T2, T3 and T4 are strings of variable lengths. As can be seen, incoming messages with particular topic notations 400 are selectively routed to communications channels 404, and the routing determination is made based on a routing table 402. The mapping of the topic subscription to the channel defines the route and is used to propagate messages throughout the publish/subscribe network. The superset of all these routes, or mapping between subscriptions and channels, defines the routing table. The routing table is also referred to as the subscription table. The subscription table for routing via string-based topics can be structured in a number of ways, but is preferably configured for optimizing its size as well as the routing lookup speed. In one implementation, the subscription table may be defined as a dynamic hash map structure, and in another implementation the subscription table may be arranged in a tree structure as shown in the diagram of FIG. 5

A tree includes nodes (e.g., T₁, . . . T₁₀) connected by edges, where each sub-string of a topic subscription corresponds to a node in the tree. The channels mapped to a given subscription are stored on the leaf node of that subscription indicating, for each leaf node, the list of channels from where the topic subscription came (i.e. through which subscription requests were received). This list indicates which channel should receive a copy of the message whose topic notation matches the subscription. As shown, the message routing lookup takes a message topic as input and parse the tree using each substring of that topic to locate the different channels associated with the incoming message topic. For instance, T₁, T₂, T₃, T₄ and T₅ are directed to channels 1, 2 and 3; T₁, T₂, and T₃, are directed to channel 4; T₁, T₆, T₇, T* and T₉ are directed to channels 4 and 5; T₁, T₆, T₇, T₈ and T₉ are directed to channel 1; and T₁, T₆, T₇, T* and T₁₀ are directed to channel 5.

Although selection of the routing table structure is intended to optimize the routing table lookup, performance of the lookup depends also on the search algorithm for finding the one or more topic subscriptions that match an incoming message topic. Therefore, the routing table structure should be able to accommodate such algorithm and vice versa. One way to reduce the size of the routing table is by allowing the routing algorithm to selectively propagate the subscriptions throughout the entire publish/subscribe network. For example, if a subscription appears to be a subset of another subscription (e.g., a portion of the entire string) that has already been propagated, there is no need to propagate the subset subscription since the MAs already have the information for the superset of this subscription.

Based on the foregoing, the preferred message routing protocol is a topic-based routing protocol, where entitlements are indicated in the mapping between subscribers and respective topics. Entitlements are designated per subscriber or groups/classes of subscribers and indicate what messages the subscriber has a right to consume or which messages may be produced (published) by such producer (publisher). These entitlements are defined in the P&M system, communicated to all MAs in the publish/subscribe network, and then used by the MA to create and update their routing tables.

Each MA updates its routing table by keeping track of who is interested in (requesting subscription to) what topic. However, before adding a route to its routing table, the MA has to check the subscription against the entitlements of the publish/subscribe network. The MA verifies that a subscribing entity, which can be a neighboring MA, the P&M system, a CE or an API, is authorized to do so. If the subscription is valid, the route will be created and added to the routing table. Then, because some entitlements may be known in advance, the system can be deployed with predefined entitlements and these entitlements can be automatically loaded at boot time. For instance, some specific administrative messages such as configuration updates or the like might be always forwarded throughout the network and therefore automatically loaded at start-up time.

In addition to its role in the subscription process, the P&M system has a number of other management functions. These additional functions include publish/subscribe system configuration and health monitoring and reporting. Configuration involves both physical and logical configuration of the publish/subscribe system network and components. The monitoring and reporting involves monitoring the health of all network and system components and reporting the results automatically, per demand or to a log.

The P&M is a centralized, single-point provisioning and management platform for the publish/subscribe system. It provides the ability to configure and monitor all components in the message publish/subscribe system at a central location, as well as optionally provision software and firmware in the system. Thus, the P&M system is said to have provisioning and configuration management functional components. Also, the P&M system can be integrated with external provisioning and management system to leverage existing solutions.

When the provisioning functional component of a P&M system is enabled, the provisioning of each message publish/subscribe system component (i.e., the provisioning of each appliance, device or sub-system, where a system component can be an edge MA, core MA, API etc.) is done via administrative messages and allows a system administrator to remotely turn on or off functionalities and remotely schedule or ‘push’ software and firmware image upgrades, automatically or manually. Examples of software or firmware images include software packages, full operating system (OS) disk images, firmware binary images, etc. Each system component has a core module and, optionally, one or more business modules. These modules can be upgraded independently by pushing a new software image.

The P&M system with the provisioning functionality enabled as described above, allows for automatic scheduling of module upgrades, which renders the management of a message publish/subscribe system more controllable, scalable and cost-effective. The P&M system further provides software image versions control by keeping track of which business modules and features are enabled and what software image version each of them is running. In one embodiment, upon detecting the failure of a software image associate with a business module, the P&M system is designed to automatically downgrade the module to the last-known functioning version of the software image.

The configuration management functional component of the P&M system is designed for user management and user entitlements (i.e., right to subscribe and publish data). All applications using the API and all external data sources and destinations (whose messages are converted by the protocol transformation engine) are associated with a user (e.g., via client application). This user has to be authenticated by the P&M system before any publication and/or subscription event is allowed. Various authentication methods are possible, including password, pre-shared key or token, and PKI certificate. Once the user is authenticated, the user is allowed to subscribe to or publish data accordingly to its user entitlements. Based on information from the P&M system, the MA verifies user entitlements when they attempt to publish messages or subscribe to messages in the publish/subscribe system message traffic. Such user and entitlements management framework enables distributed access functionality on a global scale.

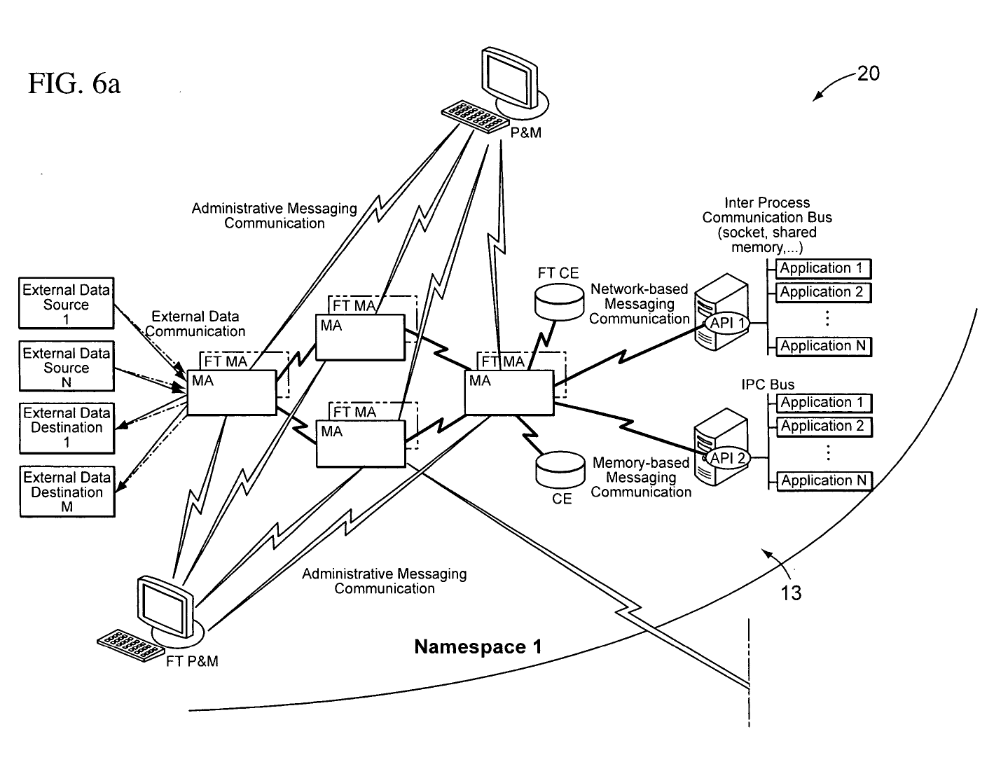

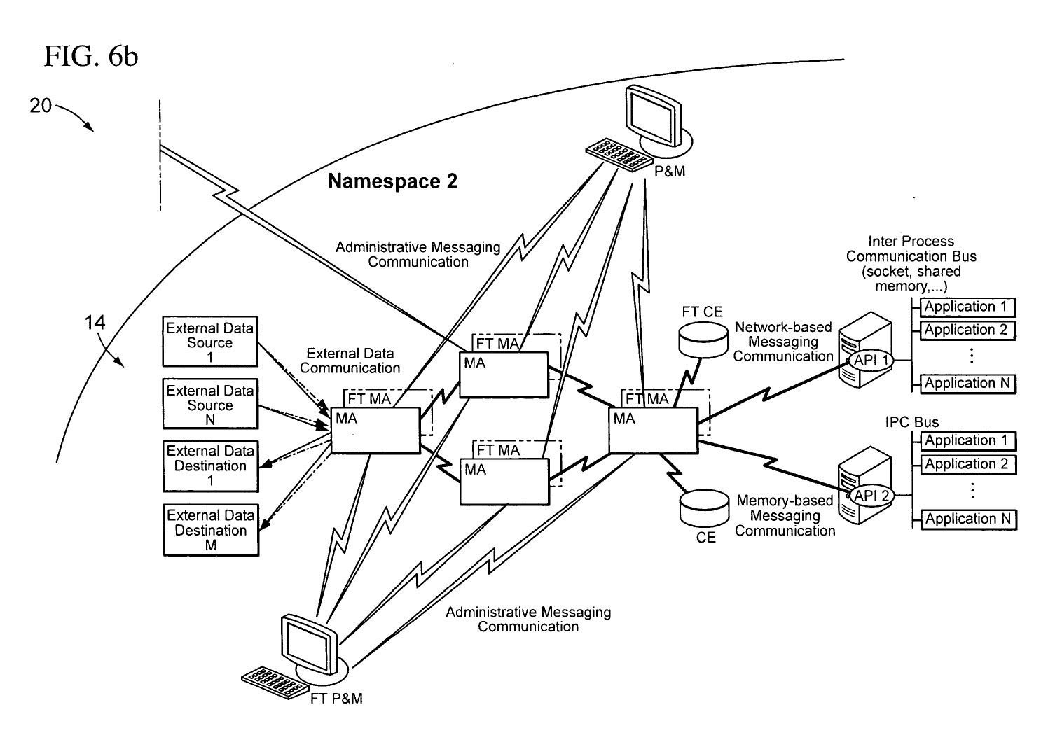

In addition, the P&M system allows the system administrator to define a message namespace associated with each of the messages routed throughout the message publish/subscribe system. Accordingly, a message publish/subscribe system can be physically and/or logically divided into name-space-based sub-system. This namespace-based topology is illustrated in FIG. 6.

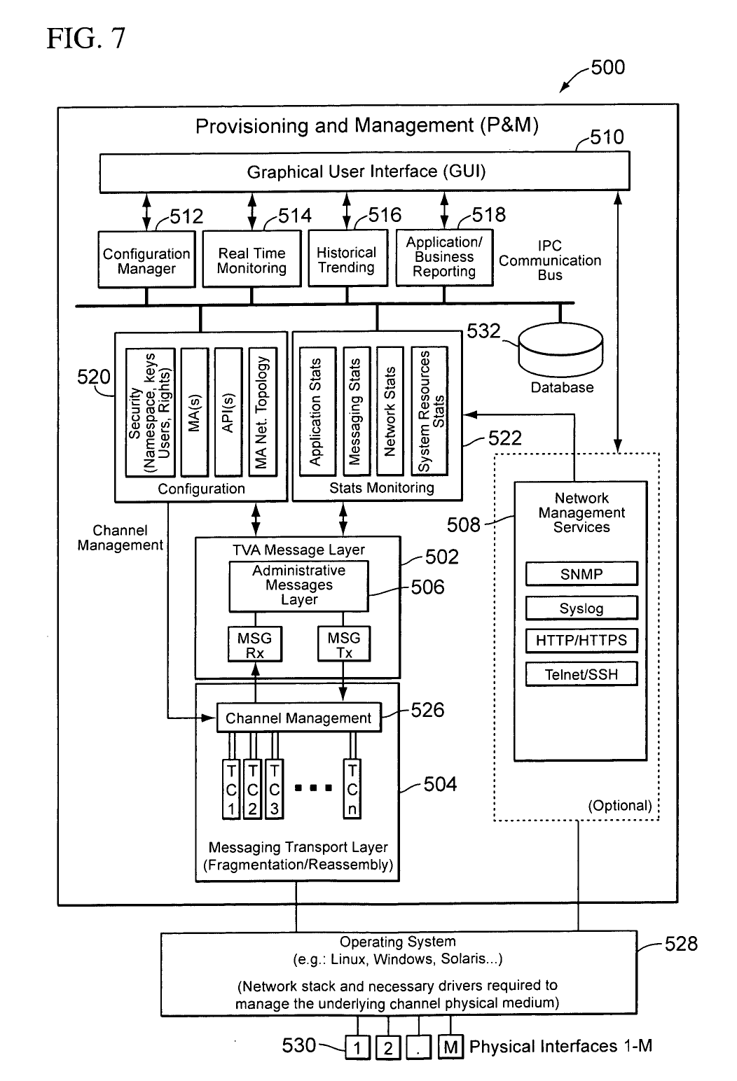

The namespace is unique for each publish/subscribe sub-system 13, 14. Therefore, in the combined message publish/subscribe system each publish/subscribe sub-system has a unique namespace assigned to it. In this example, the publish/subscribe network is composed of two publish/subscribe sub-systems, the first one with namespace ‘Namespace 1’ and the second one with namespace ‘Namespace 2’. It is the namespace management feature of a P&M system (in items 520, 512 at FIG. 7) that provides the capacity to define different administrative domains and enable topic-based message communications across these different administrative domains while avoiding topic collisions or duplications.

In one example, a publish/subscribe sub-system ‘A’ publishes news updates that are routed towards the publish/subscribe sub-system ‘B’ and sub-system ‘C’ publishes news updates that are also routed towards the sub-system ‘B’. However, if sub-systems ‘A’ and ‘C’ publish the same news updates on the same topic, sub-system ‘B’ can differentiate between the news coming from ‘A’ and those that came from ‘C’ because of their associated namespace. In many instances, these namespace domains will be different intra-organizational domains. In other instances, these domains will be different organization or legal entities domains. In other words, the namespace feature may be used by an organization to limit entitlements to its data or content to certain users in or outside the organization. For users within the organization, this is done by issuing a namespace license to these users; and for users outside the organization, this is done by issuing a namespace license to the organization provided it has an MA.

The foregoing example shows how to implement the digital rights management (DRM) functionality by leveraging namespaces. Moreover, users that consume data from different sources can determine the best source of data by looking at the performance metrics of the data source (e.g., latency). Alternatively, users of data from different sources can perform data reconciliation and validation by comparing the data from these different sources.

The P&M system is also able to remotely control all the network management configuration of all the deployed physical components in the message publish/subscribe system. For instance, this includes the NIC configuration (IP address/network mask, speed, duplex, MTU, etc.), VLAN interface, local IP routing, SNMP MIBs that are available for polling, the remote access methods such as SSH, telnet, http and https, other network services such as DNS, NTP, etc.

The P&M system provides a view of the virtual fully meshed overlay network in the publish/subscribe system, with all the publish/subscribe neighbours (e.g., the MAs, CEs and APIs) and all the logical connections between them. The system administrator can select which logical connection should be active or inactive. As a result, the P&M system controls the exact topology of the overlay publish/subscribe network, and how the messages are going to be routed throughout the message publish/subscribe system.

A third functional component of the P&M system is the real-time monitoring of message publish/subscribe system health and events generated by the system components. This aspect is described later in greater details when going over the architecture of the P&M system.

A fourth functional component of the P&M system is the end-to-end system performance control and monitoring. With the topology information available, it is possible to identify the business-message flow throughout the message publish/subscribe system and control the resources allocated for such information flow. Thus, it is possible to predict and assure the expected and required performance levels. For instance, the P&M system can be designed to allow a system administrator to define the messaging traffic management policies, such as message prioritization, quality of service, real-time behavior of adaptive services such as protocol optimization service, message flow control, message conflation and intelligent message routing.

In addition, the P&M systems can be designed to allow the specification of resource reservations, such as the number of CPU cycles required to perform some message processing task from a system end-to-end point of view, the amount of bandwidth required from one edge of the publish/subscribe network to another, the maximum acceptable latency per messaging hop, the maximum end-to-end latency, etc. These parameters can be defined for a given user, for a given subscription, for a given channel, or for a given logical connection between two neighbours.

The P&M system can both be queried by and push information to the system components. The push function can be useful to manually control the behavior of any of these system components. Note that both caching engines (CEs) and APIs interface with the P&M system via the MA that acts as a proxy for them. The only neighbor that communicates directly with the P&M system is the MA. When the provisional functional component is enabled, the push function further allows the P&M system to upgrade any software and firmware image from a single point of administration.

To illustrate in more detail the architecture of a P&M system, FIG. 7 is a block diagram illustrating a P&M system in accordance with one embodiment of the invention. As shown, the P&M system 500 can be deployed as a standalone appliance that communicates to one or more MAs in the publish/subscribe network. In an alternative embodiment, the P&M system can be integrated into an MA.

The P&M system performs its configuration, monitoring and reporting functions via administrative messages that are obtained from the administrative message layer 506 in the appliance message layer 502. Communications with other components in the network are done via the messaging transport layer 504 with all the aforementioned channel management which is typical to components in a system configured in accordance with the principles of the present invention. However, unlike the message transport layer in the MA which interacts directly with the physical medium interfaces, the P&M system is often implemented on top of the operating system 528 (OS) through which the messaging transport layer communicates with the physical medium interfaces (interfaces 1 . . . N). Hence, in order to support the various types of channels, the OS may require particular drivers for each physical medium that would not otherwise be made available with the OS. The OS might also require a particular interface card for the medium (e.g., direct connect interface card or Infiniband interface card).

The P&M might also use a network management stack 508 to communicate with the network-based management services. Examples of such network-based services include SNMP (simple network management protocol), system logging, HTTP/HTTPS (hypertext transfer protocol over Secure Socket Layer), Telnet/SSH (Secure Shell Protocol).

The P&M may be provided with a graphical user interface (GUI) 510 built on top of a number of functional blocks. Examples of such functional blocks include the configuration manager 512, the real-time monitoring block 514, the historical trending block 516, and the business-logic/application reporting block 518. The configuration manager functional block handles the configuration of all the physical components involved in the publish/subscribe network. The configuration 520 of each of these components involves a number of aspects including, for instance, security, encryption, authentication, entitlements (rights in terms of which users are allowed to subscribe to what topics), and topology (including communication paths between these different components).

The real-time monitoring functional block 514 listens to (sniffs) the various events 522 occurring in the publish/subscribe network. Examples of these events include new subscription requests from API, new subscribers connected to the Publish/subscribe network, real-time statistics on different hardware components in the networked publish/subscribe system, size of routing tables for all MAs and levels of resource utilization.

The historical trending block 516 is preferably tightly linked to the real-time monitoring subsystem because a trend can be established over time, from events that are monitored in real-time. To this end, the historical trending block takes its input from the real-time monitoring subsystem, and stores each data point in a real-time database. The historical trending block can then query the real-time database and chart the events it retrieves as a function of time. This block can be further used to track the publish/subscribe network behavioral patterns over time.

The business logic reporting block 518 provides another level of reporting by correlating the raw data of event patterns over time in order to help in the business decision making process. In one implementation, the business logic reporting block translates into business metrics the low-level message and network metrics data (typical raw data), examples of which include message and frame rate, network delay, jitter and loss data.

Optionally also, the real time monitoring and business logic reporting block is used to monitor service level agreements (SLA) and verify that a specific level of service is met over time. When an SLA is not met, it allows understanding and legal proof of where the problem is and how it is observed, assuming that all parties have agreed on the validity of such reports. Furthermore, establishing trends of historical metrics might help understand the changes in messaging infrastructure, and it might give an insight into long term messaging traffic patterns. As a result, it becomes a very valuable input in the business decision process.

To support its management and monitoring operations, the P&M system maintains in a back-end database the configurations, monitored statistics, optional software and firmware images and optional business modules. Also, as mentioned above, for availability and reliability of the system and consistency and persistency of the message data it is advantageous to configure the P&M system as a fault tolerant system which uses a form of database replication or data synchronization.

Specifically, the P&M system can be deployed as a fault-tolerant pair, where it is possible that the primary and secondary P&M systems are located in similar or different geographic locations. Because the P&M systems need to be synchronized, it is possible to implement the synchronization by leveraging the back-end database replication feature. It is alternatively possible to implement the synchronization at the messaging level where the P&M system is responsible for notifying the secondary P&M system of any change in the back-end database. These notifications might be communicated by sending administrative messages containing the database delta (change) that occurred since the last synchronization and should be applied to the secondary database.

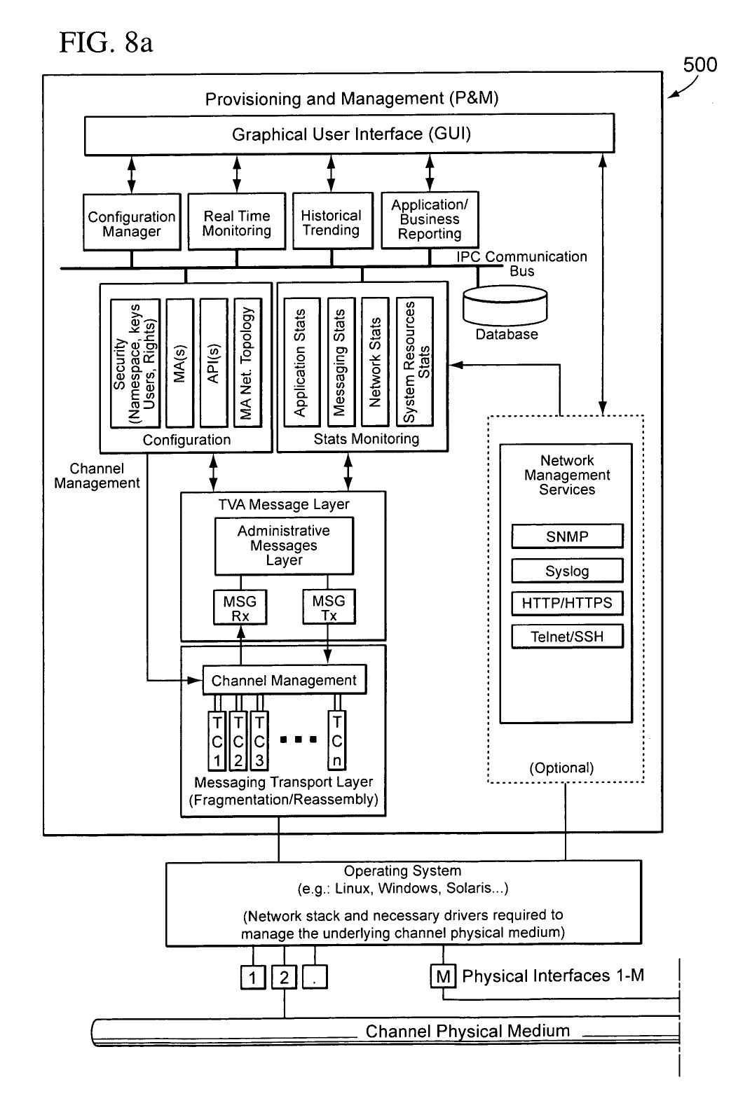

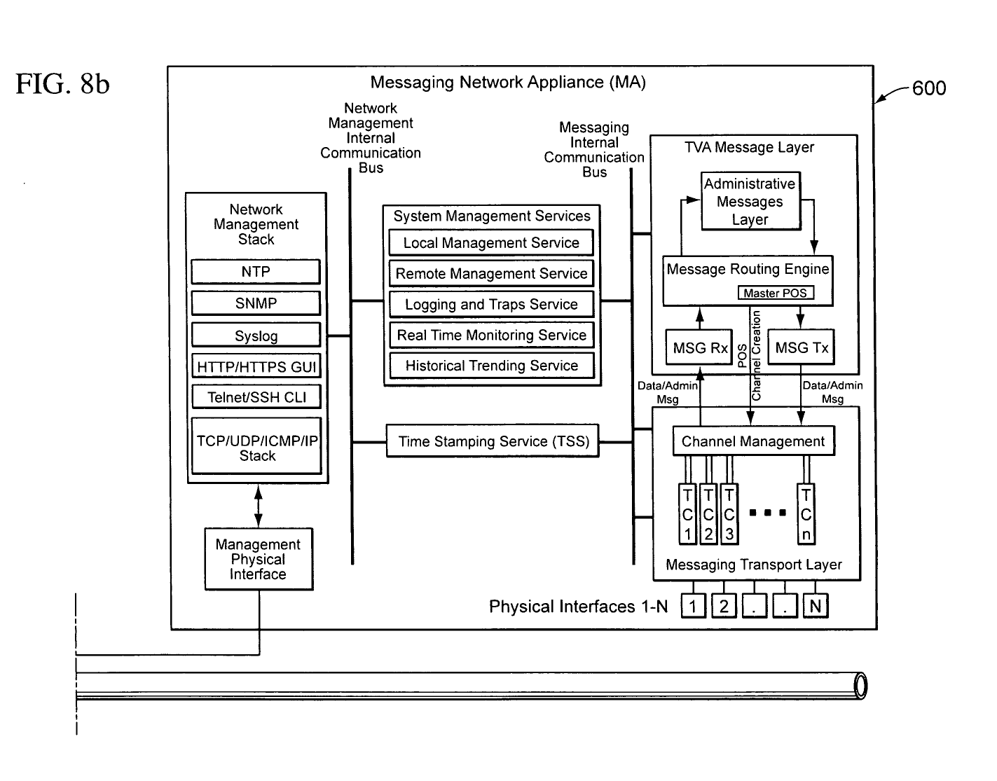

For configuration and monitoring of the system components, communication is performed via administrative messages. Accordingly, in order to communicate with the MAs, the P&M system uses in the illustrated embodiment the channel-based messaging stack 508 (along with message layer 502, message transport layer 504 and channel management 526). FIG. 8 is a diagram illustrating the communication between the P&M system and one of the MAs.

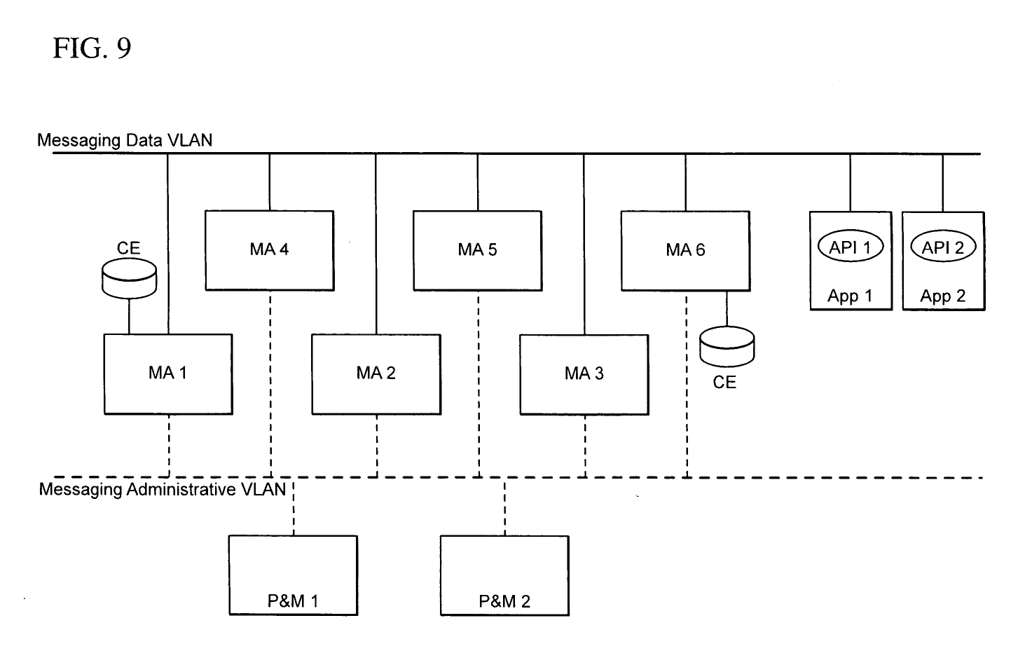

However, in order to physically and logically separate the management traffic from the data traffic, it is possible to configure two different VLAN (Virtual LAN) in the underlying switched fabric with each MA being physically connected to each VLAN, as shown in FIG. 9. This approach has the benefit of preserving the integrity of the data traffic. To further protect the data traffic from being delayed or affected by the management traffic, the different switches and routers can be configured to provide the required Quality of Service (QoS) for the data VLAN. As a result, both the configuration updates and monitoring statistics will be routed on the management VLAN without affecting the overall performance and real-time behavior of the message publish/subscribe network. In addition, all the management traffic is received or sent by the control plane of the MA. And, therefore it does not affect the data plane that is responsible for the routing of data traffic. As illustrated, in one embodiment all MAs are connected to both VLANs via two different physical interfaces and each of the P&M systems is able to configure and monitor all the MAs by communicating with them via the management and administrative VLAN. Note also that the CEs are connected directly to the MA and therefore the traffic exchanged between the MA and the CE does not affect any other messaging traffic. Additionally, the applications, via their respective APIs, are connected to the data VLAN.

In sum, the present invention provides a new approach to messaging and more specifically the end-to-end middleware architecture with a P&M system that improves the effectiveness of messaging systems. Although the present invention has been described in considerable detail with reference to certain preferred versions thereof, other versions are possible. Therefore, the spirit and scope of the appended claims should not be limited to the description of the preferred versions contained herein.

What is claimed is:

1. A messaging system with provisioning and management, comprising:
one or more than one messaging appliance operative for receiving and routing messages, including administrative and data messages;
an interconnect; and
one or more than one provisioning and management system linked to the one or more messaging appliances via the interconnect and operative to provide centralized, single-point management for the messaging system via communications of administrative messages, the single-point management including configuration management, messaging system monitoring and reporting.

2. A messaging system as in claim 1, wherein the interconnect includes a plurality of fabrics one fabric of which being used for administrative messages and another fabric of which being used for data messages.

3. A messaging system as in claim 2, wherein each provisioning and management system interfaces with the messaging appliances via the fabric for administrative messages, and wherein each of the messaging appliances is separately connected to each of the plurality of fabrics.

4. A messaging system as in claim 3, wherein the fabrics are virtual networks including one or any combination of LANs (local area networks) and WANs (wide area networks).

5. A messaging system as in claim 1, wherein each messaging appliance is further operative to execute the routing of messages by dynamically selecting, in real time, a message transmission protocol and a message routing path.

6. A messaging system as in claim 1, further comprising one or more caching engines connected to respective one or more of the messaging appliances, and one or more applications interfacing with respective ones of the messaging appliances via application programming interfaces, wherein the messaging appliances are operative to function as proxies for respective ones of the caching engines and application programming interfaces in communications between them and each respective provisioning and management system.

7. A messaging system as in claim 1, wherein the configuration management involves management of: users, digital rights, namespace, entitlements, quality of service, security, encryption, network services, network links and system topology.

8. A messaging system as in claim 1, wherein the messaging system monitoring involves system health and event monitoring.

9. A messaging system as in claim 1, wherein the messaging system monitoring includes monitoring of performance metrics including network bandwidth, message flow rates, frame rates, messaging hop latency, end-to-end latency, system behavior and protocol optimization services.

10. A messaging system as in claim 9, wherein each provisioning and management system is further operative to control resources associated with message communication paths based on the performance metrics.

11. A messaging system as in claim 9, wherein the protocol optimization services select between unicast, multicast or broadcast protocols.

12. A messaging system as in claim 1, wherein the messaging system reporting functions to report any status changes including new registrations of users and applications, new publication and subscription events and network messaging connection and disconnection.

13. A messaging system as in claim 1, wherein the provisioning and management system is further operative for administering subscriptions, including subscription of consumers and external data destinations to one or more data message topics and subscription of messaging appliances to administrative message topics.

14. A messaging system as in claim 6, wherein each of the applications is operative to send requests, including registration and subscription requests, to a respective one of the messaging appliances, and wherein each provisioning and management system is further operative to handle digital rights management where each respective messaging appliance is operative to confirm report to the provisioning and management system whether an application attempting to register or subscribe with it is entitled to do so.

15. A messaging system as in claim 14, wherein the subscription requests establish topic-based subscriptions, and wherein a single subscription request is capable of establishing subscriptions to a group of related topics.

16. A messaging system as in claim 1, in which the interconnect is one or more fabrics over which the messaging appliances and provisioning and management systems are deployed, the fabrics being configured with any number of routers, switches and subnets.

17. A messaging system as in claim 1, wherein the interconnect includes a channel-based, fabric agnostic physical medium.

18. A messaging system as in claim 1, wherein the messaging appliances, provisioning and management systems and interconnect incorporate transport logic.

19. A messaging system as in claim 18, configured for transport transparent channel-based messaging where messages are communicated in native protocol format independent of the transport logic.

20. A messaging system as in claim 1, wherein each provisioning and management system is operative to perform a namespace management function which includes digital rights management.

21. A messaging system as in claim 20, wherein, with the namespace management, subscribers that are subscribed to topics associated with a particular namespace are entitled to subscribe to messages identified with such topics and namespace.

22. A messaging system as in claim 1, wherein the messages have a topic-based format, each message having a header and a payload, the header including a topic field in addition to source and destination namespace identification fields.

23. A messaging system as in claim 22, wherein the topic field includes a variable-length string or a key, the key being a unique value where, for keys, each provisioning and management system has a database for maintaining a mapping between each such key and its respective topic the provisioning and management system being further operative for updating each of the messaging appliances about any changes in this mapping.

24. A messaging system as in claim 1, wherein the messages include a subscription message with a topic field that has a variable-length string with any number of wild card characters for matching it with any topic substring provided that such topic and the subscription message have the same number of topic substrings.

25. A messaging system as in claim 5, wherein the dynamic selection of transmission protocol and message routing path is based on system topology, health and performance reports from the respective provisioning and management system and it involves one or both of dynamic resource allocation and dynamic channel creation and/or selection.

26. A messaging system as in claim 1, having boundaries that transcend regional, national or continental borders, with subsystems in each region, country or continent, wherein the subsystems are linked via a networking infrastructure-and each subsystem includes a provisioning and management system, interconnect and one or more messaging appliances.

27. A messaging system as in claim 1, wherein each provisioning and management system is integrated into one of the messaging appliances or is implemented as a standalone appliance.

28. A messaging system as in claim 1, wherein each provisioning and management system includes message transport and native message layers linked to a configuration functional block and a monitoring functional block which is, in turn, connected via an inter-process communications bus to management blocks that encompass configuration management, real time monitoring, historical trending and application business reporting functional blocks.

29. A messaging system as in claim 28, wherein each provisioning and management system further includes one or both of: a network management service connected on one side to the monitoring functional block and on the other side to the network stack of the operating system, and a user interface connected to the management blocks.

30. A messaging system as in claim 28, wherein the interconnect includes the transport channel and physical medium through which the messaging appliance communicates with each provisioning and management system.

31. A messaging system as in claim 1, wherein each provisioning and management system includes user interface, messaging logic and a back-end database.

32. A messaging system as in claim 31, wherein via the user interface each provisioning and management system provides a view of the messaging system topology with its fully meshed overlay network and publish/subscribe neighbors information, with the view allowing selection of logical connections within the messaging system, and activation and deactivation of such logical connections.

33. A messaging system as in claim 1, wherein each provisioning and management system is further operative to provide a centralized, single point provisioning functionality including software and firmware version control and update management and scheduling.

34. A messaging system as in claim 33, wherein, for the software and firmware version control and update management and scheduling, each provisioning and management system is further operative to keep track of which business modules are enabled and what software or firmware image version each of them is running.

35. A messaging system as in claim 33, wherein, for the software and firmware version control and update management and scheduling, each provisioning and management system is further operative to allow for automatic scheduling of business module upgrades.

36. A messaging system as in claim 33, wherein for the software and firmware version control and update management and scheduling, each provisioning and management system is further operative to downgrade a business module to a last-known functioning version of its software or firmware image automatically upon detecting the failure of a current version thereof.

37. A messaging system as in claim 1, wherein each of the messaging appliances and provisioning and management systems are configured for fault tolerance.

38. A messaging system as in claim 1, in which the provisioning and management systems are each arranged in fault tolerant pairs each pair including a primary and secondary provisioning and management system, the secondary provisioning and management system taking over for the primary provisioning and management system upon its failure.

39. A messaging system as in claim 37, wherein for the fault tolerance each provisioning and management system is operative to provide database replication or data synchronization at a messaging level.

40. A messaging system as in claim 1, wherein one or more of the provisioning and management systems are integrated with an external authentication and entitlement system.

41. A messaging system as in claim 40, wherein integration of the provisioning and management system with the external authentication and entitlement system enables uniform user authentication and entitlements.
